(19) United States
(12) Patent Application Publication
(10) Pub. No.: US 2022/0354108 A1
(43) Pub. Date: Nov. 10, 2022

(54) PRESERVATION METHODS USING TREHALOSE WITH OTHER CRYOPROTECTANTS BEING ABSENT FROM THE CRYOPRESERVATION PROTOCOL

(71) Applicant: TISSUE TESTING TECHNOLOGIES LLC, North Charleston, SC (US)

(72) Inventors: Kelvin G.M. BROCKBANK, Charleston, SC (US); Lia H. CAMPBELL, Mount Pleasant, SC (US)

(73) Assignee: TISSUE TESTING TECHNOLOGIES LLC, North Charleston, SC (US)

(21) Appl. No.: 17/731,616

(22) Filed: Apr. 28, 2022

Related U.S. Application Data
(60) Provisional application No. 63/183,678, filed on May 4, 2021.

(51) Int. Cl. A01N 1/02

(52) U.S. Cl. CPC A01N 1/0221; A01N 1/0284

(57) ABSTRACT

Cellular material containing living cells is preserved by combining the cellular material with a cryoprotectant formulation/medium/solution containing an effective amount of trehalose (in the absence of DMSO and/or any other added cryoprotectants) during a cryopreservation protocol. That is, the cryopreservation protocol is free of cryoprotectant other than trehalose, and the cryopreservation protocol includes: exposing the cellular material to a cryoprotectant formulation containing an effective amount of the trehalose to act as a cryoprotectant, cooling the cellular material at a cooling rate in the range of from −3° C./minute to −50° C./minute to a predetermined temperature below −20° C., and obtaining a cryopreserved cellular material that has been warmed.

### CROSS-REFERENCE TO RELATED APPLICATION

This nonprovisional application claims the benefit of U.S. Provisional Application No. 63/183,678 filed May 4, 2022. The disclosure of the prior application is hereby incorporated by reference in its entirety.

### STATEMENT REGARDING FEDERALLY SPONSORED RESEARCH

This invention was made with government support under Grant HL142371 from the National Heart, Lung and Blood Institute of the US National Institutes of Health. The government has certain rights in the invention.

### TECHNICAL FIELD

The present disclosure relates to the field of cell and tissue preservation, particularly the invention relates to methods of cryopreservation of cellular materials, such as, for example, stem cells, hematopoietic stem cells, lymphocytes, white blood cells, T cells (and T-cell subsets and CAR T-cells) and pancreatic islets, that employ trehalose, but do not include other added cryoprotectants, such as dimethyl sulfoxide (DMSO), glycerin/glycerol, ethylene glycol, propylene glycol or the like.

### BACKGROUND

Most cells used in research are cryopreserved after addition of 5-10% DMSO to cells in suspension in cryovials followed by slow rate cooling at approximately −1° C./min, with or without induced nucleation at a high subzero temperature (usually greater than −10° C.), and storage at −80° C. or below −135° C.

However, there are cell types and tissues that are difficult to preserve and situations where cell yield is critical such as for cell therapy applications. Alternative protocols and solutions that improve cell viability and yield and allow for the preservation of cell types that are traditionally hard to preserve are needed. Effective preservation solutions and protocols are required as new cell therapies are developed and cell and tissue-based screening assays for drug development become more prevalent, so that the potential use and benefits of emerging therapies, such as stem cell transplants and assays can be realized.

With the increasing demand to get drugs to market quicker and less expensively, better and more cost-effective high throughput screening technologies and services are required. The shortening of the lead-time between discovery and validation is an important area of development and pharmaceutical companies are shifting their focus to defining how potential drugs are toxic. Cell and tissue based assays are the trend for such screening. More than twenty years ago, 1997, pharmaceutical and biotechnology companies were already spending $42 billion worldwide on research and development with screening accounting for approximately $5.9 billion. Environmental companies are moving away from remediation and cleanup activities to monitoring and quality control. Additionally, increasingly companies are using outside sources for screening products and services. In all these areas, cell and tissue assay systems that provide cost effective, reliable and quantitative results are desired. Thus, preservation methodology that would increase the availability of cellular products and increase the efficiency of using such products is highly desired.

DMSO is the most effective cryoprotectant that has been discovered and the most widely used. Cell cryopreservation usually involves slow cooling rate freezing with DMSO in culture medium and storage below −135° C. for later use. Examples where cell yield and viability can be very important include minimization of expensive delays when starting cultures for bioreactor protein manufacturing runs and cellular therapies that involve administering cells into patients for treatment of various diseases, such as cancer. While some cells, for example fibroblasts, are easily cryopreserved other cell types like keratinocytes, hepatocytes, and cardiac myocytes do not freeze well and cell yields are often well below 50%.

The current opinion is that DMSO should be removed before cells are infused into patients (Caselli et al., Respiratory depression and somnolence in children receiving dimethylsulfoxide and morphine during hematopoietic stem cell transplantation. Haematologica, 94:152-3, 2009; Junior et al., Neurotoxicity associated with dimethyl sulfoxide-preserved hematopoietic progenitor cell infusion. Bone Marrow Transplant, 41:95-6, 2008; Mueller et al., Neurotoxicity upon infusion of dimethylsulfoxide-cryopreserved peripheral blood stem cells in patients with and without pre-existing cerebral disease. Eur J Haematol, 78:527-31, 2007; Otrock et al., Transient global amnesia associated with the infusion of DMSO-cryopreserved autologous blood stem cells. Haematologica, 93:36-7, 2008; and Schlegel et al., Transient loss of consciousness in pediatric recipients of dimethylsulfoxide (DMSO)-cryopreserved peripheral blood stem cells independent of morphine co-medication. Haematologica, 94:1473-5, 2009). Thus, increasing the time it takes to effectively use such cells.

The mechanism for DMSO cytotoxicity has not been determined, however, it is thought to modify membrane fluidity, induce cell differentiation, cause cytoplasmic microtubule changes and metal complexes (Barnett, The effects of dimethylsulfoxide and glycerol on Na+, K+-ATPase and membrane structure. Cryobiology. 1978; 15(2):227-9; Katsuda et al., The influence of dimethyl sulfoxide on cell growth and ultrastructural features of cultured smooth muscle cells. J Electron Microsc (Tokyo). 1984; 33(3):239-41; Katsuda et al., Dimethyl sulfoxide induces microtubule formation in cultured arterial smooth muscle cells. Cell Biol Int Rep. 1987; 11(2):103-10; Miranda et al., Alteration of myoblast phenotype by dimethyl sulfoxide. Proc Natl Acad Sci USA. 1978; 75(8):3826-30). DMSO also decreases expression of collagen mRNAs in a dose-dependent manner (Zeng et al., Dimethyl Sulfoxide Decrease Type-I and -III Collagen Synthesis in Human Hepatic Stellate Cells and Human Foreskin Fibroblasts. Advanced Science Letters, 3:496-499, 2010). More recently DMSO impact on cell cycle progression and meiotic spindle organization (Li et al., Dimethyl Sulfoxide Perturbs Cell Cycle Progression and Spindle Organization in Porcine Meiotic Oocytes. PLoS One. 2016 Jun. 27; 11(6):e0158074), protein aggregation (Giugliarelli et al., Evidence of DMSO-Induced Protein Aggregation in Cells. J Phys Chem A. 2016 Jul. 14; 120(27):5065-70) and gross molecular changes that have the potential to interfere with various cellular processes (Tuncer et al., Low dose dimethyl sulfoxide driven gross molecular changes have the potential to interfere with various cellular processes. Sci Rep. 2018; 8(1):14828) have been reported.

Thus, there is a need for cell cryopreservation methods that either avoid or improve upon outcomes employing DMSO as a cryoprotectant. In this regard, disaccharides such as trehalose have been widely investigated as cryoprotectants. The predominant hypothesis for trehalose to be an effective cryoprotectant is that it should be present on both sides of the cell membrane. Trehalose is not metabolized by mammalian cells and there are no active mammalian transport mechanisms for uptake of trehalose. Thus, before the invention of the methodology of the present disclosure, the use of trehalose (alone) was anticipated to have very low viability and metabolic function values (particularly in the absence of DMSO).

The methodology of the present disclosure addresses the above needs and provides improvements over existing cell and tissue therapies by providing more efficient, cost effective and safer methods of storage and transportation for cellular materials for a wide variety of potential applications. See FIG. 1.

The methodology of the present disclosure also seeks to increase the availability of cellular materials, such as, for example, stem cells, hematopoietic stem cells, mesenchymal stem cells (such as human mesenchymal stem cell, lymphocytes, white blood cells, T cells (and T-cell subsets and CAR T-cells), and pancreatic islets) and enables increased use of these life changing cellular materials (in some cases, the cells could be directly used and/or infused into the patient post-thaw without any intervening steps). Applications for methodology of the present disclosure also include cell and tissue research, cell and tissue based engineered regenerative medicine products as well as cell and tissue banking for transplantation and toxicology screening.

### SUMMARY OF THE INVENTION

The present disclosure provides improved preservation methods using trehalose in the absence of other added conventional cryoprotectants (such as DMSO, glycerin/glycerol, ethylene glycol, propylene glycol or the like, particularly DMSO) in cryopreservation protocols.

In some embodiments, the present disclosure is directed to providing cryopreservation methodology that achieves protective effects and low toxicity for cells or tissues by replacing conventional cryoprotectants (e.g., those that are known to be toxic, such as DMSO, and/or those that are designed to be removed after the cells or tissues are cryopreserved at −80° C. or below and rewarmed). The methodology of the present disclosure provides an inexpensive and safe method for cryopreservation without using highly toxic cryoprotectants (such as DMSO or other conventional cryopreservation agents that are used when the cells are immersed in a cryopreservation liquid and then cryopreserved at −80° C. or below). Because conventional cryoprotectants, such as DMSO or the like, are not used, the toxicity experienced by the cells (during the preservation process, storage, during and after rewarming) is kept low and the cells are able to be directly used and/or infused into the patient post-thaw without any intervening steps. In some embodiments, the thawed cells or tissues may be suspended in a culture medium to immediately (i.e., directly after the rewarming process) start a culturing process (e.g., with no washing after the thawing of cells or tissues).

In some embodiments, the methodology of the present disclosure is directed to cryopreservation of cultured cells in a manner that maintains all cell functions (e.g., of cells including, for example, stem cells, pancreatic islets, mesenchymal stem cells, etc.,). Thus, efficiency in the use and/or transplantation of these cells is improved. For example, in some embodiments, the methodology of the present disclosure is directed to providing on-demand, off-the-shelf bone marrow-derived human mesenchymal stem cell(s) (hMSC(s)) ready for therapeutic use without the need for further processing/washing after rewarming from storage. In some embodiments, the methodology of the present disclosure is directed to cryopreservation of Pan T-cells using trehalose where the methods do not include other added cryoprotectants, such as DMSO or other conventional cryopreservation agents that are used (such as glycerin/glycerol, ethylene glycol, propylene glycol or the like) when the cells are immersed in a cryopreservation liquid and then cryopreserved at −80° C. or below.

### BRIEF DESCRIPTION OF THE DRAWINGS

FIG. 1 is an illustration of potential patient populations that may ultimately benefit from cell and tissue therapies (the total US patient population is 122 million).

FIG. 2 is an illustration of the data obtained with respect to experiments showing the effect of cooling rate on hMSC viability after cryopreservation in the indicated concentrations of trehalose without and DMSO versus DMSO only controls; data is shown as the mean±1 standard error of the mean.

FIGS. 3A and 3B are illustrations of data obtained with respect to cell survival after cryopreservation at −15° C./minute using combinations of DMSO and trehalose (Cells were cryopreserved and rewarmed using various concentrations of DMSO & trehalose. Cryostor-5 that contains 5% DMSO was used as a control. Cell counts, live and dead, (FIG. 3A) as well as metabolic activity (FIG. 3B) was measured. Values are the mean (±SEM) of 9 replicates from 3 experiments at 0.2-0.6M trehalose and Cryostor-5 control with 3 replicates from 1 experiment for 0.8M trehalose).

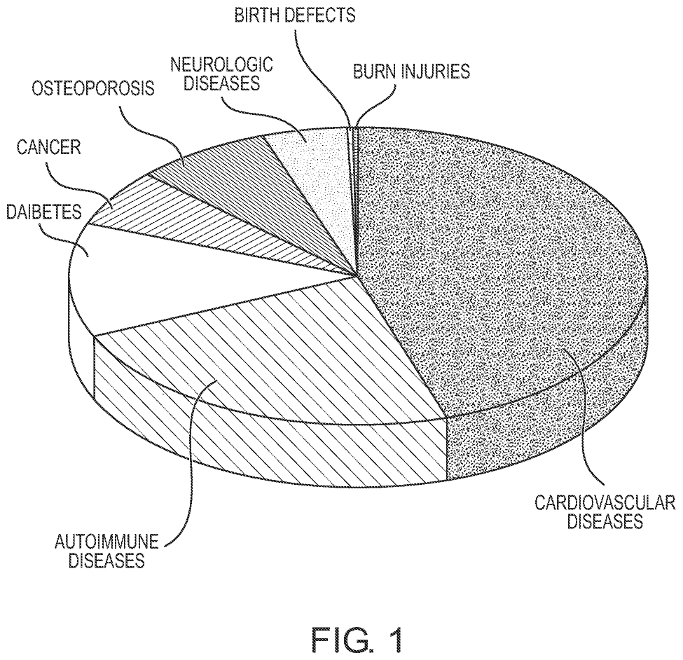

### DETAILED DESCRIPTION

Terminology and Definitions

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components (i.e., apart from other cryoprotectants) other than those cited. In the summary and this detailed description, each numerical value should be read once as modified by the term “about” (unless already expressly so modified), and then read again as not so modified unless otherwise indicated in context.

As used herein, the term “about” used in connection with a quantity is inclusive of the stated value and has the meaning dictated by the context. For example, it includes at least the degree of error associated with the measurement of the particular quantity. When used in the context of a range, the modifier “about” should also be considered as disclosing the range defined by the absolute values of the two endpoints. For example, the range “from about 2 to about 4” also discloses the range “from 2 to 4.”

Unless otherwise expressly stated herein, the modifier “about” with respect to temperatures (° C.) refers to the stated temperature or range of temperatures, as well as the stated temperature or range of temperatures+/−1-4% (of the stated temperature or endpoints of a range of temperatures) of the stated. Regarding cell viability and cell retention (%), unless otherwise expressly stated herein, the modifier “about” with respect to cell viability and cell retention (%) refers to the stated value or range of values as well as the stated value or range of values+/−1-3%. Regarding expression contents, such as, for example, with the units in either parts per million (ppm) or parts per billion (ppb), unless otherwise expressly stated herein, the modifier “about” with respect to cell viability and cell retention (%) refers to the stated value or range of values as well as the stated value or range of values+/−1-3%. Regarding expressing contents with the units μg/mL, unless otherwise expressly stated herein, the modifier “about” with respect to value in μg/mL refers to the stated value or range of values as well as the stated value or range of values+/−1-4%. Regarding molarity (M), unless otherwise expressly stated herein, the modifier “about” with respect to molarity (M) refers to the stated value or range of values as well as the stated value or range of values+/−1-2%. Regarding, cooling rates (° C./min), unless otherwise expressly stated herein, the modifier “about” with respect to cooling rates (° C./min) refers to the stated value or range of values as well as the stated value or range of values+/−1-3%.

Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Additionally, for example, +/−1-4% is to be read as indicating each possible number along the continuum between 1 and 4. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

As used herein, the term “room temperature” refers to a temperature of about 18° C. to about 25° C. (at standard pressure). In various examples, room temperature may be about 18° C., about 19° C., about 20° C., about 21° C., about 22° C., about 23° C., about 24° C., or about 25° C.

As used herein, “cellular material” or “cellular sample” refers to living biological material containing cellular components, whether the material is natural or man-made and includes cells, tissues and organs, whether natural or man-made. Such terms also mean any kind of living material to be cryopreserved, such as cells, tissues and organs. In some embodiments, the cells, tissues and organs may be mammalian organs (such as human organs), mammalian cells (such as human cells) and mammalian tissues (such as human tissues).

As used herein, the term “cell(s)” comprises any type of cell, such as, for example, stem cells, hematopoietic stem cells, lymphocytes, white blood cells, T cells (and T-cell subsets and CAR T-cells), pancreatic islets, somatic cells (including all kind of cells in tissue or organs), fibroblasts, keratinocytes, hepatocytes, cardiac myocytes, chondrocytes, smooth muscle cells, progenitor cells, oocytes, and germ cells. Such cells may be in the form of a tissue or organ. In some embodiments, the cells are from a mammal tissue or organ, such as a human tissue or organ described above.

As used herein, “preservation protocol” or “cryopreservation protocol” refers to a process for preservation of shelf life to a cell containing, living biological material. Preservation protocols may include cryopreservation by freezing, vitrification and/or anhydrobiotic preservation by either freeze-drying or desiccation.

As used herein, the term “freezing” refers to preservation methods in which ice formation is encouraged. Not only physical changes, water forming ice, but also chemical changes take place as the temperature is reduced and freezing occurs that subsequently affect the viability and survival of cells and tissues upon thawing. As the temperature is reduced, heat is removed and molecular processes are slowed which leads to a variety of structural and functional changes within the cells even before freezing. As a consequence, the cell experiences a cascade of biochemical and biophysical changes that sensitize the cell to further injury and can lead to irreversible damage.

If the cells are cryopreserved by freezing, ice forms initially in the extracellular space. Pure water separates as ice crystals so that remaining solutes are concentrated in the remaining liquid phase. As a consequence, water moves across the plasma membrane and out of the cell in an effort to reestablish osmotic equilibrium within the extracellular space. If the cells are cooled too rapidly, less time is allowed for water to move out of the cells and intracellular ice is allowed to form which causes irreparable damage to the cell. If cells are cooled too slowly, more water is allowed to leave the cells increasing the solute concentration within the cell. This increase in solute concentration both inside and outside the cell has been termed “solution effects” injury because it encompasses a number of changes that include increase in salt concentrations which can denature proteins and membranes, precipitation of buffers, pH changes, increased concentration of proteins allowing for the possibility of cross linking or simple removal of structurally important water. The cells also become concentrated at slower cooling rates as they are pushed together by the forming ice. Eventually the cells are isolated in ice-free vitrified channels and can be stored at cryogenic storage temperatures. Maximum cell viability is usually achieved at an intermediate cooling rate that balances osmotic dehydration and the risk of intracellular ice formation. Rapid cooling permits intracellular ice formation

During rewarming the process is reversed, ice is replaced with water, and cryoprotective agents (CPA) are removed from the system. However, physical and chemical changes to bring the cells back to physiologic temperature can still cause damage. As the sample is warmed recrystallization can occur. Recrystallization is when metastable ice crystals formed during freezing are given an opportunity to reform larger crystals during rewarming. These ice crystals can cause damage to the cells in a similar manner as those crystals that were formed during freezing. Another concern during rewarming is the removal of the cryoprotectants. The CPAs were added to the samples prior to freezing and for compounds like DMSO, they replace the water that has been removed from the cells. As DMSO does not move across the cell membrane as readily as water, an imbalance can develop so that the cells will tend to take up water faster than the DMSO is removed causing swelling. Too much swelling can cause irreversible damage to the cell so even if the freezing protocol worked, if the rewarming is not controlled appropriately, cell survival will still not be very good. All these factors affect the overall survival of cells during cryopreservation. Therefore, optimization for a given cell type may be required (Baust J M, Campbell L H, Harbell J W. (2017) Best practices for cryopreserving, thawing, recovering and assessing cells. In Vitro Cell Dev Biol Anim. 53(10): 855-871).

As used herein, the term “vitrification” refers to solidification either without ice crystal formation or without substantial ice crystal formation despite the fact that in cryopreservation by freezing the cells are preserved in vitrified channels within an otherwise frozen sample. In some embodiments, a sample to be preserved (e.g., such as a tissue or cellular material) may be vitrified such that vitrification and/or vitreous cryopreservation (in its entirety-from initial cooling to the completion of rewarming) may be achieved without any ice crystal formation. In some embodiments, a sample to be preserved (e.g., such as a tissue or cellular material) may be vitrified such that vitrification and/or vitreous cryopreservation may be achieved where the solidification of the sample to be preserved (e.g., such as a tissue or cellular material) may occur without substantial ice crystal formation (i.e., the vitrification and/or vitreous cryopreservation (in its entirety-from initial cooling to the completion of rewarming) may be achieved even in the presence of a small, or restricted amount of ice, which is less than an amount that causes injury to the tissue).

As used herein, a sample to be preserved (e.g., such as an organ, a tissue or cellular material) is vitrified when it reaches the glass transition temperature (Tg). The process of vitrification involves a marked increase in viscosity of the cryoprotectant solution as the temperature is lowered such that ice nucleation and growth are inhibited. Generally, the lowest temperature a solution can possibly supercool to without freezing is the homogeneous nucleation temperature Tₕ, at which temperature ice crystals nucleate and grow, and a crystalline solid is formed from the solution. Vitrification solutions have a glass transition temperature T_{g}, at which temperature the solute vitrifies, or becomes a non-crystalline solid.

As used herein, the “glass transition temperature” refers to the glass transition temperature of a solution or formulation under the conditions at which the sample shifts from a more liquid phase into a solid phase where all molecular motion ceases, a glass transition is observed in both vitrified and frozen samples. In general, the methodology of the present disclosure is conducted at physiological pressures. However, higher pressures can be used as long as the sample to be preserved (e.g., such as a tissue or cellular material) is not significantly damaged thereby.

As used herein, “physiological pressures” refer to pressures that tissues undergo during normal function. The term “physiological pressures” thus includes normal atmospheric conditions, as well as the higher pressures that various tissues, such as vascularized tissues, undergo under diastolic and systolic conditions.

As used herein, the term “sugar” may refer to any sugar. In some embodiments, the sugar is a polysaccharide. As used herein, the term “polysaccharide” refers to a sugar containing more than one monosaccharide unit. That is, the term polysaccharide includes oligosaccharides such as disaccharides and trisaccharides, but does not include monosaccharides. The sugar may also be a mixture of sugars, such as where at least one of the sugars is a polysaccharide. In some embodiments, the sugar (apart from trehalose) may be at least one member selected from the group consisting of a disaccharide and a trisaccharide. In some embodiments, the sugar (apart from trehalose) is a disaccharide, such as sucrose. In some embodiments, the sugar (apart from trehalose) is a trisaccharide, such as raffinose. The sugar (apart from trehalose) may also be a combination sucrose and/or raffinose and/or other disaccharides or trisaccharides.

As used herein, the term “functional after cryopreservation” in relation to a cryopreserved material means that the cryopreserved material, such as organs or tissues or cells, after cryopreservation retains an acceptable and/or intended function after cryopreservation. In some embodiments, the cellular material after cryopreservation retains all its intended function. In some embodiments, the cellular cryopreserved material preserved by the methods of the present disclosure retains at least 50% of the intended function, such as at least 60% of the intended function, such as at least 70% of the intended function, such as at least 80% of the intended function, such as at least 90% of the intended function, such as at least 95% of the intended function, such as 100% of the intended function. For example, along with preserving the viability of the cells, it may be important to also maintain/preserve the physiological function of the cells and/or the ability of a tissue/cell (e.g., those to be transplanted) to integrate with surrounding tissue.

As used herein, the term “sterile” means free from living germs, microorganisms and other organisms capable of proliferation.

As used herein, the term “substantially free of cryoprotectant other than trehalose” means a cryoprotectant (other than trehalose) in an amount less than 0.01 w/w %. In some embodiments, the methods of the present disclosure may use and/or achieve a medium/solution and/or cellular material that is substantially free of cryoprotectant (other than trehalose), such as a cellular material that is substantially free of DMSO (i.e., the DMSO is in an amount less than 0.01 w/w %). In some embodiments, the methods of the present disclosure may use and/or achieve a medium/solution and/or cellular material that is substantially free of any added cryoprotectant other than the trehalose. The cryoprotectant other than trehalose that may be excluded in this regard may be one or more cryoprotectant that are conventionally used when the cells are immersed in a cryopreservation liquid and then cryopreserved at −80° C. or below, or one or more of the following cryoprotectants (commonly added for that function): DMSO, glycerin, acetamide, agarose, alginate, alanine, albumin, ammonium acetate, anti-freeze proteins, butanediols (such as 2,3-butanediol), chondroitin sulfate, chloroform, choline, cyclohexanediols, cyclohexanediones, cyclohexanetriols, dextrans, diethylene glycol, dimethyl acetamide, dimethyl formamide (such as n-dimethyl formamide), dimethyl sulfoxide, erythritol, ethanol, ethylene glycol, ethylene glycol monomethyl ether, formamide, glucose, glycerol, glycerophosphate, glyceryl monoacetate, glycine, glycoproteins, hydroxyethyl starch, inositol, lactose, magnesium chloride, magnesium sulfate, maltose, mannitol, mannose, methanol, methoxy propanediol, methyl acetamide, methyl formamide, methyl ureas, methyl glucose, methyl glycerol, phenol, pluronic polyols, polyethylene glycol, polyvinylpyrrolidone, proline, propanediols (such as 1,2-propanediol and 1,3-propanediol), pyridine N-oxide, raffinose, ribose, serine, sodium nitrate, sodium nitrite, sodium sulfate, sorbitol, triethylene glycol, trimethylamine acetate, urea, valine and xylose.

### Embodiments

This disclosure describes methodology (including, for example, rapid cooling rates, that is cooling rates that are faster than the traditional slow rate cooling in the vicinity of 1° C./minute rate employed for nucleated mammalian cells) and compositions that contain trehalose in the absence of any other conventional cryoprotectants, such as DMSO, glycerin/glycerol, ethylene glycol, propylene glycol or the like, from the cryopreservation protocol, or methodology and compositions that are free and/or substantially free of cryoprotectant other than trehalose.

The cryopreservation methodology described herein uses trehalose. A sample to be preserved may be submerged in or perfused with a cryoprotectant formulation including trehalose in the absence of conventional cryoprotectants, such as DMSO, or methodology and compositions that are free or substantially free of cryoprotectant other than trehalose, or may be submerged in or perfused with a cryoprotectant formulation that is free or substantially free of added cryoprotectant other than trehalose. The use of trehalose is in conjunction with rapid cooling rates, where the rapid cooling rates to be in the range of from greater than 1° C./minute to about 80.0° C./minute (such as during cooling from a temperature in the range of from about 37° C.-0.0° C. to about −80° C. or below, or from a temperature in the range of from about 37° C.-0.0° C. to about −135° C. or below), or in the range of from about 3° C./minute to about 50.0° C./minute (such as during cooling from a temperature in the range of from about 37° C.-0.0° C. to about −80° C. or below, or from a temperature in the range of from about 37° C.-0.0° C. to about −135° C. or below), or in the range of from about 10° C./minute to about 30.0° C./minute (such as during cooling from a temperature in the range of from about 37° C.-0.0° C. to about −80° C. or below, or from a temperature in the range of from about 37° C.-0.0° C. to about −135° C. or below), or in the range of from about 15° C./minute to about 25.0° C./minute (such as during cooling from about 37° C. to about −80° C. or below, or from about 37° C. to about −135° C. or below).

In some embodiments, the rapid/fast cooling may be performed by plunge-freezing into liquid nitrogen before cells are transferred to their final storage temperature freezer.

In the methods of the present disclosure, the metabolic activity of the cellular material being preserved may be fully recovered to control values (i.e., without intermediate washing steps following thawing; thus, reducing processing time and variability) within 6 hours of being rewarmed, 24 hours of being rewarmed, or within 48 hours of being rewarmed, or within 96 hours of being rewarmed. The control values being assessed/set with a fresh cellular material being of an identical cell type to that of the cellular material exposed to the trehalose formulation in a suitable growth media for that particular tissue being preserved. The restored metabolic activity is maintained (such as for a period of hours, days, or at least 3 days, or a period of at least 5 days, or a period of at least 7 days) until the cryopreserved cellular materials preserved by the methods of the present disclosure is put to the intended use thereof, including, for example, research or therapeutic uses (e.g., transplantation).

In embodiments, this disclosure describes a cryoprotective composition including trehalose in the absence of conventional cryoprotectants (such as DMSO), cryoprotective compositions that are free or substantially free of added cryoprotectant other than trehalose, effective for thawing a cryopreserved sample that includes tissue/cellular material with minimal damage to the tissue/cellular material. The cryoprotective agent/formulation can include any other material (apart from additional cryoprotectants, other than additional sugars) suitable for the cryopreservation of biomaterials.

The methods of the present disclosure comprise bringing a cellular material (such as, for example, stem cells, hematopoietic stem cells, lymphocytes, white blood cells, T cells (and T-cell subsets and CAR T-cells) and pancreatic islets) into contact with a cryoprotectant solution containing an effective amount of trehalose in the absence of conventional cryoprotectants (such as DMSO). In some specific embodiments, at least one other sugar, such as a disaccharide (e.g., sucrose), may also be present in the cryoprotectant formulation/solution in an amount effective to provide an environment more conducive to survival of the cells of the cellular material (such as, for example, stem cells, hematopoietic stem cells, lymphocytes, white blood cells, T cells (and T-cell subsets and CAR T-cells) and pancreatic islets) during cooling and rewarming.

In some embodiments, the cellular cryopreserved material (such as, for example, stem cells, hematopoietic stem cells, lymphocytes, white blood cells, T cells (and T-cell subsets and CAR T-cells) and pancreatic islets) preserved by the methods of the present disclosure retains at least 50% of the intended function, such as at least 60% of the intended function, such as at least 70% of the intended function, such as at least 80% of the intended function, such as at least 90% of the intended function, such as at least 95% of the intended function, such as 100% of the intended function.

In embodiments, the formulation/solution/medium comprising the trehalose may be contacted with the sample to be preserved for any desired duration, such as until a desired dosage (such as an effective dosage) of the trehalose is present on/in the cells or tissues to afford an improved viability (post-cryopreservation), and/or to prevent/protect against tissue damage upon warming.

In some embodiments, the cells to be cryopreserved may also be in contact with a freezing-compatible pH buffer comprised of, for example, at least a basic salt solution, an energy source (for example, glucose), and a buffer capable of maintaining a neutral pH at cooled temperatures. Well known such materials include, for example, Dulbecco's Modified Eagle Medium (DMEM). This material may also be included as part of the cryopreservation composition. See, e.g., Campbell et al., “Cryopreservation of Adherent Smooth Muscle and Endothelial Cells with Disaccharides,” In: Katkov I. (ed.) Current Frontiers in Cryopreservation. Croatia: In Tech (2012); and Campbell et al., “Development of Pancreas Storage Solutions: Initial Screening of Cytoprotective Supplements for β-cell Survival and Metabolic Status after Hypothermic Storage,” Biopreservation and Biobanking 11(1): 12-18 (2013). The disclosures of which are each hereby incorporated by reference in their entireties.

In some embodiments, the trehalose and/or optional other sugars (in total, including trehalose and any other the sugars, if present) may be present (i.e., in the absence of conventional cryoprotectants (such as DMSO)) at any effective amount in the cryopreservation composition, such as in an amount of from, for example, about 100 mM to about 900 mM, about 150 mM to about 800 mM, about 200 mM to about 700 mM, about 250 mM to about 600 mM, about 275 mM to about 500 M, about 300 mM to about 450 mM.

The cryopreservation composition also may include (or be based on) a solution well suited for storage of cells, tissues and organs. The solution may include well known pH buffers. In some embodiments, the solution may be, for example, the EuroCollins Solution, which is composed of dextrose, potassium phosphate monobasic and dibasic, sodium bicarbonate, and potassium chloride, described in Taylor et al., “Comparison of Unisol with Euro-Collins Solution as a Vehicle Solution for Cryoprotectants,” Transplantation Proceedings 33: 677-679 (2001). The disclosure of which is hereby incorporated by reference in its entirety. Alternatively the cryoprotectant solution may be formulated in an alternative solution, such as Unisol, Hypothermosol (BioLife Solutions), and Lifor (Detraxi, Inc).

The cells in the cellular materials that may be used in the methods of the present disclosure can be any suitable cell composition. In some embodiments, the cells can be stem cells, hematopoietic stem cells, lymphocytes, white blood cells, T cells (and T-cell subsets and CAR T-cells), skin cells, keratinocytes, skeletal muscle cells, cardiac muscle cells, lung cells, mesentery cells, adipose cells, stem cells, hepatocytes, epithelial cells, Kupffer cells, fibroblasts, neurons, cardio myocytes, myocytes, chondrocytes, pancreatic acinar cells, islets of Langerhans, osteocytes, myoblasts, satellite cells, endothelial cells, adipocytes, preadipocytes, biliary epithelial cells, and progenitor cells or combinations of any of these cell types. In some embodiments, such cells/tissue used in the methods of the present disclosure may be from any suitable species of animal, for example a mammal, such as a human, canine (e.g. dog), feline (e.g. cat), equine (e.g. horse), porcine, ovine, caprine, or bovine mammal.

Once the cryopreservation composition has been prepared (and trehalose in the absence of any other added conventional cryoprotectants (such as DMSO, glycerin/glycerol, ethylene glycol, propylene glycol or the like) is associated with the cellular material to be preserved), the cooling for cryopreservation may be conducted at the rapid cooling rate described above (e.g., where trehalose alone is used in the media around the cellular material to be preserved, without placing it inside the cells (i.e., extracellular trehalose), if faster cooling rates than those conventionally used with DMSO is employed), and may use any additional materials to those described above. Such as those additional materials discussed in the protocols for preserving cellular material that are described in the following patents and publications: U.S. Pat. No. 6,395,467 to Fahy et al.; U.S. Pat. No. 6,274,303 to Wowk et al.; U.S. Pat. No. 6,194,137 to Khirabadi et al.; U.S. Pat. No. 6,187,529 to Fahy et al.; U.S. Pat. No. 6,127,177 to Toner et al.; U.S. Pat. No. 5,962,214 to Fahy et al.; U.S. Pat. No. 5,955,448 to Calaco et al.; U.S. Pat. No. 5,827,741 to Beattie et al.; U.S. Pat. No. 5,648,206 to Goodrich et al.; U.S. Pat. No. 5,629,145 to Meryman; U.S. Pat. No. 5,242,792 to Rudolph et al.; and WO 02/32225 A2, which corresponds to U.S. patent application Ser. No. 09/691,197 to Khirabadi et al., the disclosure of which are each hereby incorporated in their entirety by reference.

The cryopreservation portion of the preservation protocol typically involves cooling cells/tissue to temperatures well below the freezing point of water, e.g., to about −80° C. or lower, more typically to about −135° C. or lower. Any method of cryopreservation known to practitioners (i.e., that can achieve the desired rapid/fast cooling rate) in the art may be used. For example, the cooling protocol for cryopreservation may be any suitable type in which the cryopreservation temperature may be lower (i.e., colder) than about −20° C., such as about −80° C. or lower (i.e., colder), or about −135° C. or lower (i.e., colder).

In some embodiments, the preservation protocol may include continuous controlled rate cooling from the point of temperature control initiation (+4 to −30° C.) to −80° C. or any of the above disclosed cooling temperatures, with the rapid rate of cooling being set depending on the characteristics of the cells/tissues being cryopreserved. For example, the cooling protocol for cryopreservation may be a rate (and/or average cooling rate, for example from the initial temperature of the sample to the cryopreservation temperature) that is greater than about −1.0° C. per minute, greater than about −4.0° C. per minute, or greater than about −6.0° C. per minute, or greater than about −8.0° C. per minute, or greater than about −10.0° C. per minute, or greater than about −14.0° C. per minute, or greater than about −25.0° C. per minute, or greater than −30° C. per minute, such as −35° C. per minute, or by being plunged frozen in liquid nitrogen.

The cooling rate (and/or average cooling rate), such as, for example, for continuous rate cooling (or other types of cooling), may be, for example, about −1 to about −80° C. per minute, about −3 to about −50° C. per minute, about −5 to about −35° C. per minute, about −7 to about −30° C. per minute, or about −10 to about −25° C. per minute; or about −4 to about −10° C. per minute, about −4° per minute to about −8° C. per minute, about −4 to about −6° C. per minute, about −6 to about −10° C. per minute, about −6 to about −9° C. per minute, about −6 to about −8° C. per minute, about −6 to about −7° C. per minute; or about −7 to about −10° C. per minute, about −7 to about −9° C. per minute, about −7 to about −8° C. per minute, about −8 to about −9° C. per minute, about −9 to about −10° C. per minute.

Once the samples to be preserved (e.g., cellular materials and/or tissues) are cooled to about −40° C. to −80° C. or lower by continuous cooling, they may be transferred to liquid nitrogen or the vapor phase of liquid nitrogen for further cooling to the cryopreservation temperature, which is typically below the glass transition temperature of the freezing solution. The samples to be preserved (e.g., cellular materials and/or tissues) may be cooled to about −40° C. to about −75° C., about −45° C. to about −70° C., about −50° C. to about −60° C., about −55° C. to about −60° C., about −70° C. to about −80° C., about −75° C. to about −80° C., about −40° C. to about −45° C., about −40° C. to about −50° C., about −40° C. to about −60° C., about −50° C. to about −70° C., or about −50° C. to about −80° C. before further cooling to the cryopreservation temperature. Alternatively the samples may be cooled to −120° C. before further cooling to the desired cryopreservation temperature.

In embodiments, heating methods may be used to warm the samples. Such methods can include, for example, convection, electromagnetic, and microwave heating.

In embodiments, the cryopreserved cellular materials preserved by the methods of the present disclosure may be put to any suitable use, including, for example, research or therapeutic uses and/or creating large supplies of cryopreserved cellular materials (such as hMSCs) for on-demand use as medical counter measures and/or regenerative medicine. Regarding therapeutic uses, the cryopreserved cellular materials may be administered to a human or animal patient to treat or prevent a disease or condition. For example, when the cryopreserved cellular materials is hMSC, the cryopreserved cellular materials will ameliorate severe health disparities in allogeneic hMSC transplantation, especially for minorities and women who have had children (Donnenberg A D, Gorantla V S, Schneeberger S, Moore L R, Brandacher G, Stanczak H M, Koch E K, Lee W A. Clinical implementation of a procedure to prepare bone marrow cells from cadaveric vertebral bodies. Regen Med. 2011; 6(6):701-6; Gragert L, Eapen M, Williams E, Freeman J, Spellman S, Baitty R, Hartzman R, Rizzo J D, Horowitz M, Confer D, Maiers M. HLA match likelihoods for hematopoietic stem-cell grafts in the U.S. registry. N Engl J Med. 2014; 371(4):339-48; Ustun C, Bachanova V, Shanley R, MacMillan M L, Majhail N S, Arora M, Brunstein C, Wagner J E, Weisdorf D J. Importance of donor ethnicity/race matching in unrelated adult and cord blood allogeneic hematopoietic cell transplant. Leuk Lymphoma. 55(2):358-64, 2014)—the chance of finding a match in the bone marrow registry for hMSC being markedly lower for racial and ethnic minorities (See Gragert, 2014).

The cryopreserved cellular materials can be administered to a patient in any suitable manner. In some embodiments, the cryopreserved cellular materials may be delivered topically to the patient (e.g. in the treatment of burns, wounds, or skin disorders). In some embodiments, the cryopreserved cellular materials may be delivered to a local implant site within a patient or by intravenous infusion. Any of these or any combination of these modes of administration may be used in the treatment of a patient.

### EXAMPLES

Experiments were performed using bone marrow-derived human mesenchymal stem cells (hMSCs) from various commercial sources Human Bone-Marrow Derived Mesenchymal Stem/Stromal Cells (hBM-MSCs) were isolated from normal healthy adult donors (purchased from a commercial source (such as Rooster-Bio) along with the appropriate growth media). Cells were grown according to the manufacturer's instructions).

While it is true that much work has been done using trehalose as a cryoprotectant (CPA), in most cases trehalose has not been used as the primary CPA, but usually as part of a cryoprotectant cocktail. Efforts to use trehalose as the primary CPA have mainly involved introducing trehalose into cells by various methods so that trehalose is present on both sides of the membrane (Stewart et al., Intracellular Delivery of Trehalose for Cell Banking, Langmuir, 2019, 35(23): 7414-7422) (Table 1) and previous work of the inventors has involved developing methods to introduce trehalose into cells prior to preservation (Brockbank et al., Lessons from nature for preservation of mammalian cells, tissues, and organs, In Vitro Cell. Dev. Biol., 2011; U.S. Pat. No. 8,017,311; Campbell et al., Cryopreservation of Adherent Smooth Muscle and Endothelial Cells with Disaccharides, Current Frontiers in Cryopreservation, 2012; Campbell et al., Comparison of electroporation and Chariot™ for delivery of β-galactosidase into mammalian cells: strategies to use trehalose in cell preservation, In Vitro Cell. Dev. Biol., 2010; Campbell et al., Culturing with trehalose produces viable endothelial cells after cryopreservation, Cryobiology 64 (2012) 240-244). See Table II (below) for various other methods in the literature that have been identified as potentially leading to intracellular delivery of disaccharides.

TABLE II
Techniques to introduce trehalose into cells*

| Existing | | |
|---|---|---|
| Techniques | Description | Pitfalls |
| H5 | Derived from α-hemolysin, | Derived from |
| | constitutively opened pore in | bacterial toxin. |
| | the membrane. Engineered | Batch |
| | with Zn+ or serum. | variation & |
| | | instability. |
| ATP | Naturally occurring p2ₓ₇ | P2ₓ₇ receptor |
| | receptor forms a non-specific | found on some |
| | pore upon binding of ATP⁴⁻ | but not all cell |
| | able to allow molecules <900 | types. |
| | daltons to pass through. | |
| Culture methods | 1) Prolonged incubation of | Works better |
| | cells with dissacharide sugars | with some |
| | at 37 C. | cells but not |
| | 2) Fluid phase endocytosis: | others. |
| | dissacharide sugars taken up | |
| | by cells (clathrin dependent | |
| | endocytotic mechanism). | |
| Temperature | A shift in temperature can | Requires |
| manipulation | cause a lipid phase transition | optimization |
| | which temporarily changes the | by cell type. |
| | membrane permeability and | |
| | allows molecules to pass | |
| | through. | |
| Electro- | Application of an electrical | Too high a |
| permeabilization | pulse to temporarily | pulse lowers |
| | permeabilize the membrane | viability: |
| | | limits |
| | | trehalose |
| | | loaded |

*Adapted from reference: Campbell et al, Cryopreservation of Adherent Smooth Muscle and Endothelial Cells with Disaccharides

Prior to the development of the methodology of the present disclosure, the need to have trehalose on both sides of the cell membrane has long been thought to be the best strategy for maximum protection by trehalose during cryopreservation (Stewart et al., Intracellular Delivery of Trehalose for Cell Banking, Langmuir, 2019, 35(23): 7414-7422). Despite the development of several methods to introduce trehalose into cells, each protocol has drawbacks and the results have been mixed about whether these methods can consistently protect cells. Studies have also been done that utilize trehalose with fast cooling rates (>50° C./minute) (Heo et al., “Universal” vitrification of cells by ultra-fast cooling, Technology (Singap World Sci), 2015, 3(1), 64-71; Liebermann et al., Potential Importance of Vitrification in Reproductive Medicine, Biology of Reproduction, Volume 67, Issue 6, 2002, pages 1671-1680). However, the faster cooling rates are used in conjunction with small volumes (≤300 μL), so that these samples are vitrified (no formation of ice). These types of protocols are mainly used for reproductive tissue processes and normally involve the use of cryoprotectant cocktails containing trehalose. Somewhat slower cooling rates (−5 to −60° C./minute) have also been used, but these studies have involved using trehalose as a supplemental cryoprotectant in a cocktail with DMSO (Barbas et al., Cryopreservation of domestic animal sperm cells, Cell and Tissue Banking, 2008, 10(1), 49-62) while the approach used in the present disclosure uses extracellular trehalose as the sole cryoprotectant.

Prior to the development of the methodology of the present disclosure, the inventors of the instant application previously assessed a nanotechnology for intracellular trehalose delivery developed by Professor Xiaoming He, University of Maryland (Zhang et al., Cold-Responsive Nanoparticle Enables Intracellular Delivery and Rapid Release of Trehalose for Organic-Solvent-Free Cryopreservation, Nano Lett. 2019, 19, 9051-9061; Rao et al., Nanoparticle-Mediated Intracellular Delivery Enables Cryopreservation of Human Adipose-Derived Stem Cells Using Trehalose as the Sole Cryoprotectant, ACS Appl Mater Interfaces, 2015, 7(8), 5017-5028), that he had shown promoted cryopreservation of adipose tissue derived hMSCs, for bone marrow-derived MSCs. Unfortunately, the trehalose nanotechnology failed during these studies, probably due to instability of the trehalose nanoparticles during storage and transport from the University of Maryland to Charleston, S.C. During these studies, it was observed that MSCs survived cryopreservation quite well when trehalose was present only extracellularly, which was being used as a negative control. Encouraged by these unanticipated results, the range of exogenous trehalose employed was expanded to 0.2-0.8M and compared −1, −5 and −15° C./minute cooling rates.

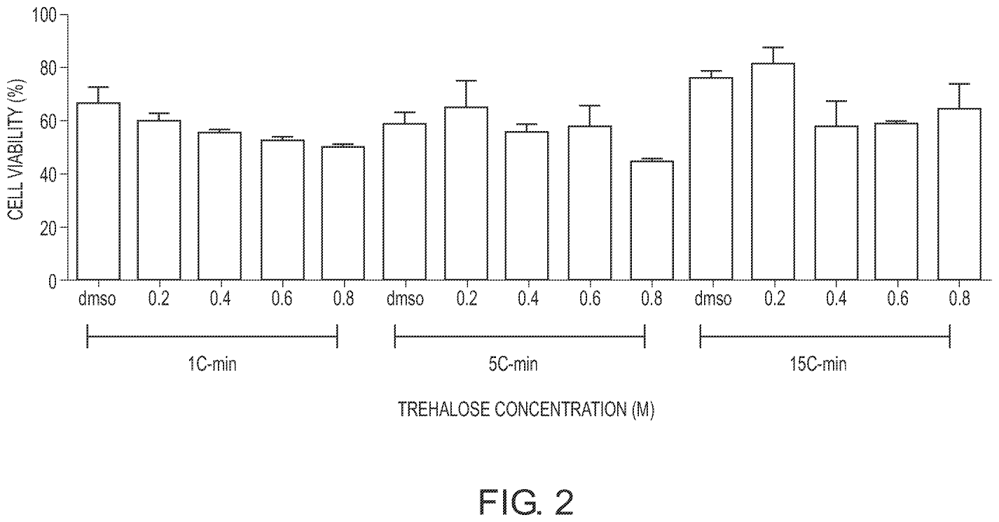

The 0.2 M trehalose groups at −5 and −15° C./minute cooling rates had the same or higher viability than the DMSO control groups at each cooling rate. FIG. 2 shows the pooled results of two experiments showing the effect of cooling rate on hMSC viability after cryopreservation in the indicated concentrations of trehalose without and DMSO versus DMSO only controls; data is shown as the mean±1 standard error of the mean.

In the preliminary experiments, the DMSO controls were clearly the best at the 1° C./minute cooling rate (65.3±2.7% of untreated controls), however, the best overall outcome was the 0.2M trehalose group at the −15° C./minute cooling rate (78.9±3.5% of untreated controls). There was a statistically significant difference between the DMSO group at −1° C./minute and the trehalose group at −15° C./minute results (p<0.05 by T test, FIG. 2). These results demonstrated an unanticipated extracellular trehalose benefit that is better at more rapid cooling rates than the ±1° C./minute usually used for cell cryopreservation by freezing with DMSO.

Similar results to those noted above were obtained with exogenous trehalose at −15° C./minute cooling rates for pan T-cells reflecting that this methodology is expected to be extendible to other cellular materials discussed in the present disclosure (e.g., including but not limited to T-cell subsets and CAR T-cells).

Experiments were performed to assess 0.2-0.8M concentrations of extracellular trehalose combined with several concentrations of 0-5% DMSO and compared with the positive control, Cryostor-5, that contains 5% DMSO.

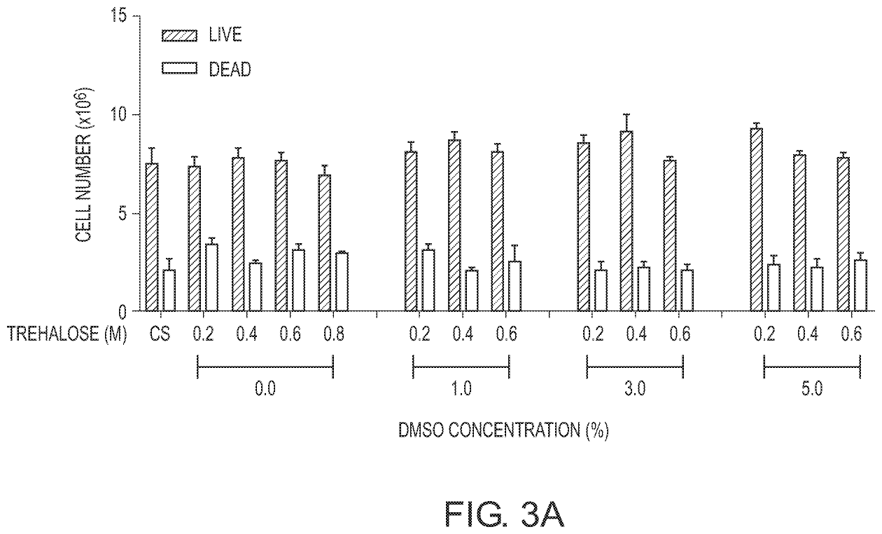

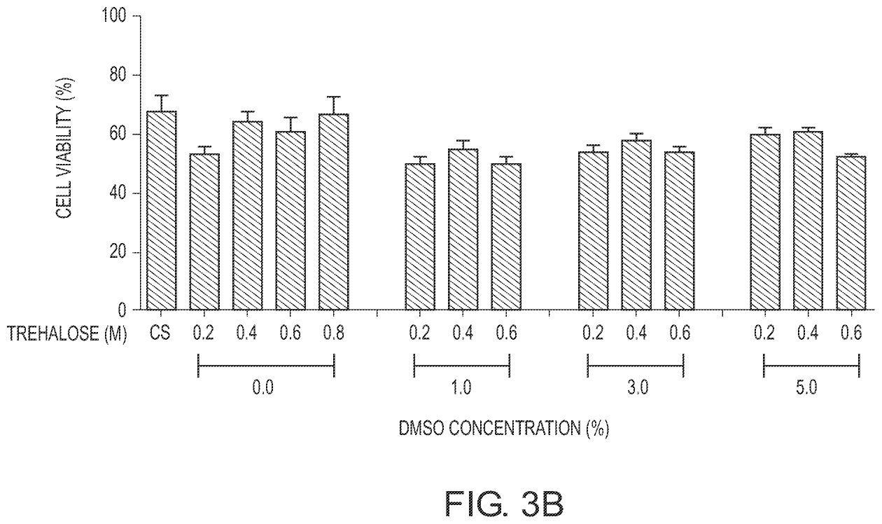

Pan T-cells were grown and expanded. The T-cells were then harvested and counted. Approximately 10×10⁶ cells were used for each sample. Cells were resuspended in the various combinations of DMSO and trehalose in 1 mL and allowed to equilibrate on ice for 20 minutes. Samples were cooled in a CRF at −15° C./minute to −80° C. then moved to liquid nitrogen vapor phase storage for approximately 10 days. After storage, samples were thawed rapidly in a 37° C. water bath, transferred to a 15 mL centrifuge tube and diluted with 10 mL culture medium. An aliquot was taken for cell counting. Then the cells were pelleted and resuspended in 3 mL culture medium and put into a 12 well plate, 1 sample/well. Cells were allowed to recover for 60 minutes in a 37° C. incubator before viability was measured using resazurin dye (300 μl). The cells were left for 3 hours at 37° C. before the plate was read using a fluorescent microplate reader at an excitation wavelength of 544 nm and an emission wavelength of 590 nm. Cell counts were done by mixing a 20 μl aliquot of cells with 20 μl trypan blue. Counts of both live and dead cells were obtained. This experiment was performed 2-3 times and the results combined. The results are shown in FIGS. 3A and 3B.

In FIGS. 3A and 3B, cell survival after cryopreservation at −15° C./minute using combinations of DMSO and trehalose. Cells were cryopreserved and rewarmed using various concentrations of DMSO & trehalose. Cryostor-5 that contains 5% DMSO was used as a control. Cell counts, live and dead, (A) as well as metabolic activity (B) was measured. Values are the mean (±SEM) of 9 replicates from 3 experiments at 0.2-0.6M trehalose and Cryostor-5 control with 3 replicates from 1 experiment for 0.8M trehalose.

These experiments demonstrated that the presence of DMSO was not required.

That is, trehalose alone provided adequate protection similar to the control, Cryostor-5. Statistical analysis of cell counts showed no significant differences between the control and experimental groups except for two instances. A significant difference was observed between the control and 5% DMSO with 0.2M trehalose (p<0.05) for live cell counts (FIG. 3A) and between the control and 0% DMSO with 0.2M trehalose (p<0.05) for dead cell counts (FIG. 3A). Analysis of cell metabolic activity showed no statistically significant differences for all groups with 0% DMSO except with 0.2M trehalose (p>0.05) where a significant difference was observed (FIG. 3B). Comparisons between the control and groups containing various concentrations of DMSO did not demonstrate significant differences except between the control and 0% DMSO with 0.2M trehalose, 1% DMSO with 0.2M and 0.6M trehalose, and 5% DMSO with 0.2M trehalose (p>0.05). The most interesting and unanticipated results were with the groups preserved using only trehalose with no DMSO. No attempt was made to introduce trehalose into the cells that is deemed necessary in the literature. Trehalose, at all but the lowest exogenous concentration, gave cell counts, viability, and metabolic activity that were similar to the positive control.

These experiments demonstrated that exogenous trehalose alone was able to protect the cells during cryopreservation and would make a suitable alternative cryoprotectant to DMSO. It is anticipated that trehalose would have less patient side effects compared with DMSO and that the cells could be directly infused into the patient post-thaw without any intervening steps.

All literature and patent references cited throughout the disclosure are incorporated by reference in their entireties. Although the preceding description has been described herein with reference to particular means, materials and embodiments, it is not intended to be limited to the particulars disclosed herein; rather, it extends to all functionally equivalent structures, methods and uses, such as are within the scope of the appended claims. Furthermore, although only a few example embodiments have been described in detail above, those skilled in the art will readily appreciate that many modifications are possible in the example embodiments without materially departing from the disclosure of PRESERVATION METHODS USING TREHALOSE WITH OTHER CRYOPROTECTANTS BEING ABSENT FROM THE CRYOPRESERVATION PROTOCOL. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A method for preserving cellular material, comprising:
subjecting a cellular material containing living cells to a cryopreservation protocol; wherein
the cryopreservation protocol is free of added cryoprotectant other than trehalose, and
the cryopreservation protocol comprises:
exposing the cellular material to a cryoprotectant formulation containing an effective amount of the trehalose to act as a cryoprotectant,
cooling the cellular material at a cooling rate in the range of from −3° C./minute to −50° C./minute to a predetermined temperature below −20° C., and
obtaining a cryopreserved cellular material that has been warmed; wherein
the cell viability percent of the cryopreserved cellular material after the cryopreserved cellular material has been warmed is greater than 50%;

2. The method of claim 1, wherein effective amount of the trehalose is in the range of from 200-800 mM.

3. The method of claim 1, wherein the cooling rate is in the range of from −5° C./minute to −30° C./minute.

4. The method of claim 3, wherein the cryopreservation protocol comprises storing the cellular material at −80° C. or below for a predetermined duration of time that is greater than one hour.

5. The method of claim 3, wherein the cryopreservation protocol comprises storing the cellular material at −135° C. or below for a predetermined duration of time that is greater than one hour.

6. The method of claim 1, wherein the cellular material comprises T-cells.

7. The method of claim 1, wherein the cellular material comprises mesenchymal stem cells.

8. The method of claim 7, wherein the mesenchymal stem cells are human mesenchymal stem cells.

9. The method of claim 1, wherein the cell viability percent of the cryopreserved cellular material after the cryopreserved cellular material has been warmed is at least 60%.

10. The method of claim 1, wherein the cell viability percent of the cryopreserved cellular material after the cryopreserved cellular material has been warmed is at least 70%.

11. A method for preserving cellular material, comprising:
subjecting a cellular material containing living cells to a cryopreservation protocol; wherein the cryopreservation protocol comprises:
exposing the cellular material to cryoprotectant formulation containing an effective amount of trehalose to act as a cryoprotectant,
cooling the cellular material at a cooling rate in the range of from −3° C./minute to −50° C./minute to a predetermined temperature below −20° C., and
obtaining a cryopreserved cellular material that has been warmed; wherein
the cell viability percent (cell viability (%)) of the cryopreserved cellular material after the cryopreserved cellular material has been warmed is greater than 50%; and
the cryopreservation protocol is free of any addition of DMSO, glycerin, acetamide, agarose, alginate, alanine, albumin, ammonium acetate, anti-freeze proteins, butanediols, 2,3-butanediol, chondroitin sulfate, chloroform, choline, cyclohexanediols, cyclohexanediones, cyclohexanetriols, dextrans, diethylene glycol, dimethyl acetamide, dimethyl formamide, n-dimethyl formamide, dimethyl sulfoxide, erythritol, ethanol, ethylene glycol, ethylene glycol monomethyl ether, formamide, glycerol, glycerophosphate, glyceryl monoacetate, glycine, glycoproteins, hydroxyethyl starch, inositol, lactose, magnesium chloride, magnesium sulfate, maltose, mannitol, mannose, methanol, methoxy propanediol, methyl acetamide, methyl formamide, methyl ureas, methyl glucose, methyl glycerol, phenol, pluronic polyols, polyethylene glycol, polyvinylpyrrolidone, proline, 1,2-propanediol and 1,3-propanediol, pyridine N-oxide, raffinose, ribose, serine, sodium nitrate, sodium nitrite, sodium sulfate, sorbitol, triethylene glycol, trimethylamine acetate, urea, valine and xylose.

12. The method of claim 11, wherein effective amount of the trehalose is in the range of from 200-800 mM.

13. The method of claim 11, wherein the cryopreservation protocol comprises cooling the cellular material at a cooling rate in the range of from −5° C./minute to −30° C./minute.

14. The method of claim 13, wherein the cryopreservation protocol comprises storing the cellular material at −80° C. or below for a predetermined duration of time that is greater than one hour.

15. The method of claim 13, wherein the cryopreservation protocol comprises storing the cellular material at −135° C. or below for a predetermined duration of time that is greater than one hour.

16. The method of claim 11, wherein the cellular material comprises T-cells.

17. The method of claim 11, wherein the cellular material comprises mesenchymal stem cells.

18. The method of claim 17, wherein the mesenchymal stem cells are human mesenchymal stem cells.

19. The method of claim 11, wherein the cell viability percent of the cryopreserved cellular material after the cryopreserved cellular material has been warmed is at least 60%.

20. The method of claim 11, wherein the cell viability percent of the cryopreserved cellular material after the cryopreserved cellular material has been warmed is at least 70%.
